(19) United States
(12) Patent Application Publication
(10) Pub. No.: US 2026/0227672 A1
(43) Pub. Date: Aug. 6, 2026

(54) System, Method, and Apparatus for Steering Light

(71) Applicant: Carnegie Mellon University, Pittsburgh, PA (US)

(72) Inventors: Adithya Pediredla, Pittsburgh, PA (US); Srinivasa Narasimhan, Pittsburgh, PA (US); Maysam Chamanzer, Pittsburgh, PA (US); Ioannis Gkioulekas, Pittsburgh, PA (US)

(21) Appl. No.: 19/154,959

(22) PCT Filed: Feb. 9, 2024
(86) PCT No.: PCT/US2024/015145

§ 371 Date: Aug. 8, 2025

(51) Int. Cl. G02F 1/33

(52) U.S. Cl. CPC G02F 1/33

(57) ABSTRACT

Provided is a system, method, and apparatus for steering light. The system includes a medium arranged in a path of at least one light beam and at least one controller configured to steer the at least one light beam by modulating a sonic waveform in the medium.

### CROSS REFERENCE TO RELATED APPLICATION

This application claims the benefit of U.S. Provisional Patent Application No. 63/444,854, filed on Feb. 10, 2023, the disclosure of which is hereby incorporated by reference in its entirety.

### GOVERNMENT LICENSE RIGHTS

This invention was made with Government support under 1730147 and 1935849 awarded by the National Science Foundation (NSF). The Government has certain rights in the invention.

### BACKGROUND OF THE INVENTION

### 1. Field

This disclosure relates generally to light steering and, in non-limiting embodiments, to methods, systems, and apparatuses for steering light without the use of moving parts.

### 2. Technical Considerations

Many imaging systems rely on the ability to steer light, either as it leaves a source or as it reaches a sensor. Examples include laser scanning projectors, LiDAR (Light Detection and Ranging) depth sensors, and microscopy techniques (confocal microscopy, light-sheet microscopy, multiphoton microscopy). Compared to full-field lighting and imaging, light steering systems help improve light efficiency, counter indirect illumination, and enhance illumination and imaging contrast. However, these advantages come at the cost of reduced acquisition speed, bulky moving hardware, and motion artifacts.

### SUMMARY

According to non-limiting embodiments or aspects, provided is a method comprising: emitting or receiving at least one light beam through a medium; providing a sonic waveform in the medium while the at least one light beam is emitted through the medium; and steering the at least one light beam by modulating the sonic waveform. In non-limiting embodiments or aspects, the method further includes: synchronizing at least one of the following: a light source of the at least one light beam with the sonic waveform, a sensor arranged to receive reflected illumination from the at least one light beam with the sonic waveform, or any combination thereof. In non-limiting embodiments or aspects, the light source comprises a laser, wherein synchronizing the light source comprises setting a pulse pattern of the laser to a frequency of the sonic waveform, and wherein emitting the at least one light beam through the medium comprises pulsing the at least one light beam based on the pulse pattern. In non-limiting embodiments or aspects, the method further includes: scanning a three-dimensional target based on steering the at least one light beam over an area including the target, the target comprising at least one of an object or scene. In non-limiting embodiments or aspects, the method further includes: projecting at least one image on a target based on steering the at least one light beam over an area of the target.

In non-limiting embodiments or aspects, wherein providing the sonic waveform in the medium comprises: arranging at least one transducer in the medium; and generating an ultrasonic wave with the at least one transducer, the sonic waveform comprising the ultrasonic wave. In non-limiting embodiments or aspects, the at least one transducer comprises a first transducer and a second transducer, the second transducer arranged at an angle relative to the first transducer. In non-limiting embodiments or aspects, the method further includes: scanning a target comprising at least one of a scene or object by steering the at least one light beam based on a ratio of frequencies from the light source and the sonic waveform, and an inter-pulse time of the light source. In non-limiting embodiments or aspects, the method further includes: identifying at least a portion of the target to be rescanned based on measured data associated with a plurality of points in the at least a portion; and rescanning the at least a portion of the target based on steering the at least one light beam. In non-limiting embodiments or aspects, the at least one light beam is emitted through the medium from a light source to a target. In non-limiting embodiments or aspects, the at least one light beam is received by a sensor through the medium from illumination reflected by a target. In non-limiting embodiments or aspects, the at least one light beam is emitted through the medium from a light source to a target, further comprising: receiving, by a sensor, at least one second light beam through the medium or a second medium from illumination reflected by the target.

According to non-limiting embodiments or aspects, provided is a system comprising: a medium arranged in a path of at least one light beam; and at least one controller configured to steer the at least one light beam by modulating a sonic waveform in the medium. In non-limiting embodiments or aspects, the system further includes a light source configured to emit the at least one light beam. In non-limiting embodiments or aspects, the system further includes at least one transducer arranged in or near the medium and configured to generate the sonic waveform in the medium. In non-limiting embodiments or aspects, the at least one transducer comprises a first transducer and a second transducer, the second transducer arranged at an angle relative to the first transducer. In non-limiting embodiments or aspects, the controller is further configured to synchronize the light source with the sonic waveform. In non-limiting embodiments or aspects, the light source comprises a laser, wherein synchronizing the light source comprises setting a pulse pattern of the laser to a frequency of the sonic waveform, and the at least one controller is configured to pulse the at least one light beam at the pulse pattern.

In non-limiting embodiments or aspects, the controller is further configured to: scan a target comprising at least one of a scene or object based on steering the at least one light beam over an area including the target. In non-limiting embodiments or aspects, the controller is further configured to: project at least one image on a target comprising at least one of a scene or object based on steering the at least one light beam over the target. In non-limiting embodiments or aspects, the controller is further configured to: identify at least a portion of the target to be rescanned based on measured data associated with a plurality of points in the at least a portion of the target; and rescan the at least a portion of the target based on steering the at least one light beam. In non-limiting embodiments or aspects, the system further includes: a sensor arranged to capture illumination reflected from a target comprising at least one of a scene or object. In non-limiting embodiments or aspects, the system further includes: a second medium, wherein at least one second light beam is received by the sensor through the second medium from illumination reflected by the target. In non-limiting embodiments or aspects, the controller is further configured to: scan a target comprising at least one of a scene or object by steering the at least one light beam based on a ratio of frequencies from the light source and the sonic waveform and an inter-pulse time of the at least one light source In non-limiting embodiments or aspects, the system further includes: at least one signal generator in communication with the controller, the controller configured to modulate the sonic waveform by generating a modulated voltage signal with the at least one signal generator. In non-limiting embodiments or aspects, the at least one signal generator comprises a first signal generator and a second signal generator, the first signal generator configured to provide a signal to at least one transducer for providing the sonic waveform, the second signal generator configured to provide signals to a light source of the at least one light beam and a sensor arranged to receive illuminated reflection from the at least one light beam.

According to non-limiting embodiments or aspects, provided is an apparatus comprising a housing including the system components recited above. According to non-limiting embodiments or aspects, provided is an apparatus comprising a non-transitory computer-readable medium including program instructions that, when executed by at least one controller, causes the at least one controller to: generate a sonic waveform in a medium; and steer at least one light beam passing through the medium by modulating the sonic waveform. In non-limiting embodiments or aspects, the program instructions further cause the at least one controller to: control a light source to emit the at least one light beam through the medium. In non-limiting embodiments or aspects, the program instructions further cause the at least one controller to synchronize the light source with the sonic waveform. In non-limiting embodiments or aspects, the light source comprises a laser, wherein synchronizing the light source comprises setting a pulse pattern of the laser to a frequency of the sonic waveform, and wherein controlling the light source to emit the at least one light beam comprises pulsing the at least one light beam at the pulse pattern. In non-limiting embodiments or aspects, the program instructions further cause the at least one controller to provide a signal to at least one transducer arranged in the medium to generate the sonic waveform.

In non-limiting embodiments or aspects, the program instructions further cause the at least one controller to scan a target comprising at least one of a scene or an object by controlling the modulation of the sonic waveform to steer the at least one light beam over the target. In non-limiting embodiments or aspects, the program instructions further cause the at least one controller to project at least one image on a target comprising at least one of a scene or object based on steering the at least one light beam over the target. In non-limiting embodiments or aspects, the program instructions further cause the at least one controller to: identify at least a portion of the target to be rescanned based on measured data associated with a plurality of points in the at least a portion; and rescan the at least a portion of the target based on steering the at least one light beam. In non-limiting embodiments or aspects, the program instructions further cause the at least one controller to: capture, with a sensor, illumination reflected from a target comprising at least one of a scene or object. In non-limiting embodiments or aspects, the illumination is captured from at least one second light beam passing through a second medium, the at least one second light beam is received by the sensor through the second medium from illumination reflected by the target. In non-limiting embodiments or aspects, the program instructions further cause the at least one controller to: modulate the sonic waveform by generating a modulated voltage signal with at least one signal generator. In non-limiting embodiments or aspects, the at least one signal generator comprises a first signal generator and a second signal generator, the first signal generator configured to provide a signal to at least one transducer for providing the sonic waveform, the second signal generator configured to provide signals to a light source of the at least one light beam and a sensor arranged to receive an illuminated reflection from the at least one light beam.

Other non-limiting embodiments or aspects will be set forth in the following numbered clauses:

Clause 1: A method comprising: emitting or receiving at least one light beam through a medium; providing a sonic waveform in the medium while the at least one light beam is emitted through the medium; and steering the at least one light beam by modulating the sonic waveform.

Clause 2: The method of clause 1, further comprising: synchronizing at least one of the following: a light source of the at least one light beam with the sonic waveform, a sensor arranged to receive reflected illumination from the at least one light beam with the sonic waveform, or any combination thereof.

Clause 3: The method of clause 1 or 2, wherein the light source comprises a laser, wherein synchronizing the light source comprises setting a pulse pattern of the laser to a frequency of the sonic waveform, and wherein emitting the at least one light beam through the medium comprises pulsing the at least one light beam based on the pulse pattern.

Clause 4: The method of any of clauses 1-3, further comprising: scanning a three-dimensional target based on steering the at least one light beam over an area including the target, the target comprising at least one of an object or scene.

Clause 5. The method of any of clauses 1-4, further comprising: projecting at least one image on a target based on steering the at least one light beam over an area of the target.

Clause 6. The method of any of clauses 1-5, wherein providing the sonic waveform in the medium comprises: arranging at least one transducer in the medium; and generating an ultrasonic wave with the at least one transducer, the sonic waveform comprising the ultrasonic wave.

Clause 7. The method of any of clauses 1-6, wherein the at least one transducer comprises a first transducer and a second transducer, the second transducer arranged at an angle relative to the first transducer.

Clause 8. The method of any of clauses 1-7, further comprising: scanning a target comprising at least one of a scene or object by steering the at least one light beam based on a ratio of frequencies from the light source and the sonic waveform, and an inter-pulse time of the light source.

Clause 9. The method of any of clauses 1-8, further comprising: identifying at least a portion of the target to be rescanned based on measured data associated with a plurality of points in the at least a portion; and rescanning the at least a portion of the target based on steering the at least one light beam.

Clause 10: The method of any of clauses 1-9, wherein the at least one light beam is emitted through the medium from a light source to a target.

Clause 11. The method of any of clauses 1-10, wherein the at least one light beam is received by a sensor through the medium from illumination reflected by a target.

Clause 12. The method of any of clauses 1-9, wherein the at least one light beam is emitted through the medium from a light source to a target, further comprising: receiving, by a sensor, at least one second light beam through the medium or a second medium from illumination reflected by the target.

Clause 13: A system comprising: a medium arranged in a path of at least one light beam; and at least one controller configured to steer the at least one light beam by modulating a sonic waveform in the medium.

Clause 14. The system of clause 13, further comprising a light source configured to emit the at least one light beam.

Clause 15: The system of clause 13 or 14, further comprising at least one transducer arranged in or near the medium and configured to generate the sonic waveform in the medium.

Clause 16: The system of any of clauses 13-15, wherein the at least one transducer comprises a first transducer and a second transducer, the second transducer arranged at an angle relative to the first transducer.

Clause 17. The system of any of clauses 13-16, wherein the controller is further configured to synchronize the light source with the sonic waveform.

Clause 18. The system of any of clauses 13-17, wherein the light source comprises a laser, wherein synchronizing the light source comprises setting a pulse pattern of the laser to a frequency of the sonic waveform, and wherein the at least one controller is configured to pulse the at least one light beam at the pulse pattern.

Clause 19: The system of clauses 13-18, wherein the controller is further configured to: scan a target comprising at least one of a scene or object based on steering the at least one light beam over an area including the target.

Clause 20. The system of clauses 13-19, wherein the controller is further configured to: project at least one image on a target comprising at least one of a scene or object based on steering the at least one light beam over the target.

Clause 21. The system of any of clauses 13-20, wherein the controller is further configured to: identify at least a portion of the target to be rescanned based on measured data associated with a plurality of points in the at least a portion of the target; and rescan the at least a portion of the target based on steering the at least one light beam.

Clause 22: The system of any of clauses 13-21, further comprising: a sensor arranged to capture illumination reflected from a target comprising at least one of a scene or object.

Clause 23. The system of any of clauses 13-22, further comprising: a second medium, wherein at least one second light beam is received by the sensor through the second medium from illumination reflected by the target.

Clause 24: The system of any of clauses 13-23, wherein the controller is further configured to: scan a target comprising at least one of a scene or object by steering the at least one light beam based on a ratio of frequencies from the light source and the sonic waveform and an inter-pulse time of the at least one light source.

Clause 25. The system of any of clauses 13-24, further comprising: at least one signal generator in communication with the controller, the controller configured to modulate the sonic waveform by generating a modulated voltage signal with the at least one signal generator.

Clause 26. The system of any of clauses 13-25, wherein the at least one signal generator comprises a first signal generator and a second signal generator, the first signal generator configured to provide a signal to at least one transducer for providing the sonic waveform, the second signal generator configured to provide signals to a light source of the at least one light beam and a sensor arranged to receive illuminated reflection from the at least one light beam.

Clause 27: An apparatus comprising a housing including the system of clauses 13-26.

Clause 28: An apparatus comprising a non-transitory computer-readable medium including program instructions that, when executed by at least one controller, causes the at least one controller to: generate a sonic waveform in a medium; and steer at least one light beam passing through the medium by modulating the sonic waveform.

Clause 29: The apparatus of clause 28, wherein the program instructions further cause the at least one controller to: control a light source to emit the at least one light beam through the medium.

Clause 30: The apparatus of clause 28 or 29, wherein the program instructions further cause the at least one controller to synchronize the light source with the sonic waveform.

Clause 31: The apparatus of any of clauses 28-30, wherein the light source comprises a laser, wherein synchronizing the light source comprises setting a pulse pattern of the laser to a frequency of the sonic waveform, and wherein controlling the light source to emit the at least one light beam comprises pulsing the at least one light beam at the pulse pattern.

Clause 32. The apparatus of any of clauses 28-31, wherein the program instructions further cause the at least one controller to provide a signal to at least one transducer arranged in the medium to generate the sonic waveform.

Clause 33. The apparatus of any of clauses 28-32, wherein the program instructions further cause the at least one controller to scan a target comprising at least one of a scene or an object by controlling the modulation of the sonic waveform to steer the at least one light beam over the target.

Clause 34. The apparatus of any of clauses 28-33, wherein the program instructions further cause the at least one controller to project at least one image on a target comprising at least one of a scene or object based on steering the at least one light beam over the target.

Clause 35. The apparatus of any of clauses 28-34, wherein the program instructions further cause the at least one controller to: identify at least a portion of the target to be rescanned based on measured data associated with a plurality of points in the at least a portion; and rescan the at least a portion of the target based on steering the at least one light beam.

Clause 36: The apparatus of clauses 28-35, wherein the program instructions further cause the at least one controller to: capture, with a sensor, illumination reflected from a target comprising at least one of a scene or object.

Clause 37. The apparatus of any of clauses 28-36, wherein the illumination is captured from at least one second light beam passing through a second medium, wherein the at least one second light beam is received by the sensor through the second medium from illumination reflected by the target.

Clause 38: The apparatus of any of clauses 28-37, wherein the program instructions further cause the at least one controller to: modulate the sonic waveform by generating a modulated voltage signal with at least one signal generator.

Clause 39. The apparatus of any of clauses 28-38, wherein the at least one signal generator comprises a first signal generator and a second signal generator, the first signal generator configured to provide a signal to at least one transducer for providing the sonic waveform, the second signal generator configured to provide signals to a light source of the at least one light beam and a sensor arranged to receive an illuminated reflection from the at least one light beam.

### BRIEF DESCRIPTION OF THE DRAWINGS

Additional advantages and details are explained in greater detail below with reference to the exemplary embodiments that are illustrated in the accompanying schematic figures, in which:

FIG. 1 is a schematic diagram of a light steering system according to non-limiting embodiments;

FIG. 2 is another schematic diagram of a light steering system according to non-limiting embodiments;

FIG. 3 is another schematic diagram of a light steering system according to non-limiting embodiments;

FIG. 4 is another schematic diagram of a light steering system according to non-limiting embodiments;

FIGS. 5(a)-(d) show 3D and 2D views of a medium being used in a light steering system according to non-limiting embodiments;

FIGS. 6(a)-(b) show further 3D and 2D views of a medium being used in a light steering system according to non-limiting embodiments;

FIGS. 7(a)-(d) show further 3D and 2D views of a medium being used in a light steering system according to non-limiting embodiments;

FIG. 8 shows further 3D views of a medium being used in a light steering system according to non-limiting embodiments;

FIG. 9 is a flow diagram of a method for light steering according to non-limiting embodiments;

FIG. 10 is a schematic diagram of a signal generator arrangement of a light steering system according to non-limiting embodiments; and

FIG. 11 illustrates example components of a computing device used in connection with non-limiting embodiments.

### DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the terms “communication” and “communicate” refer to the receipt or transfer of one or more signals, messages, commands, or other type of data. For one unit (e.g., any device, system, or component thereof) to be in communication with another unit means that the one unit is able to directly or indirectly receive data from and/or transmit data to the other unit. This may refer to a direct or indirect connection that is wired and/or wireless in nature. Additionally, two units may be in communication with each other even though the data transmitted may be modified, processed, relayed, and/or routed between the first and second unit. For example, a first unit may be in communication with a second unit even though the first unit passively receives data and does not actively transmit data to the second unit. As another example, a first unit may be in communication with a second unit if an intermediary unit processes data from one unit and transmits processed data to the second unit. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a processor, such as a CPU or GPU, a mobile device, and/or other like devices. A computing device may also be a desktop computer or other form of non-mobile computer. Reference to “a processor,” as used herein, may refer to a previously-recited processor that is recited as performing a previous step or function, a different processor, and/or a combination of processors. For example, as used in the specification and the claims, a first processor that is recited as performing a first step or function may refer to the same or different processor recited as performing a second step or function.

Light steering is a core component in scanning-based active imaging systems. For example, fluorescence microscopy techniques, such as confocal microscopy, multiphoton microscopy, light sheet microscopy, and super-resolution microscopy, use scanning to decrease scattered light and improve light efficiency and imaging contrast. Another example is LiDAR sensors found in commercial applications, such as autonomous vehicles. In these sensors, scanning decreases multipath interference and helps reduce hardware cost, removing the need for two-dimensional LiDAR arrays.

Non-limiting embodiments of the light steering systems, methods, and devices described herein may be used to implement LiDAR, and to improve the speed and reliability of scanning-based LiDAR with reduced costs.

Light steering is also used in scanning-based laser projectors to achieve high light efficiency and contrast by illuminating only where necessary. Laser projectors typically perform a 2D raster scan of the field of view, with a fast scanning axis and a slow scanning axis. The speed of the fast scanning axis limits the frame rate to the order of hundreds of kHz. In contrast, non-limiting embodiments of the light steering systems, methods, and devices described herein can operate at tens of MHz, improving the raster scan rate by at least two orders of magnitude. Additionally, raster scanners cannot project arbitrary point sequences at a fast rate, and are limited to the frame rate of the projector (e.g., 60-120 points per second) even when the projection pattern is sparse. Non-limiting embodiments described herein can provide faster projections, including a million arbitrary points per second which is three orders of magnitude faster than existing raster scanners for arbitrary point scanning.

Computational imaging techniques that use laser projectors or LiDAR are generally also scanning-based. Examples include structured light, light-transport probing, motion contrast 3D epipolar gating, light curtains, slope-disparity gating, and non-line-of-sight imaging. As a consequence, all of these techniques can become orders of magnitude faster if combined with non-limiting embodiments of the light steering systems and methods described herein.

Non-limiting embodiments of the light steering system described herein allow for scanning both transversally and axially at fast (e.g., 1 MHz or more) rates and without requiring moving parts. Through leveraging the acousto-optic effect, a transparent medium can be turned into a programmable optical device for steering a light beam through changes in a sound waveform provided inside the medium. For example, the pressure of a soundwave can spatiotemporally change the density of the medium, which changes the refractive index of the medium. The medium is therefore sonically sculpted from the pressure into a lens that dynamically changes based on the pressure profile of the sound wave so that, at any time instance, the spatially-varying refractive index of the medium causes the medium to behave as a periodic set of virtual gradient-index (GRIN) lenses, each with an aperture equal to the wavelength of the sonic waveform. The GRIN lenses bend light beams incident on the medium, with the GRIN profile determining the beam trajectory. Such lenses allow for steering at the speed of sound (e.g., 1.5 km/s in water) and are reconfigurable at MHz frequencies, allowing for light to be steered faster than mechanical devices.

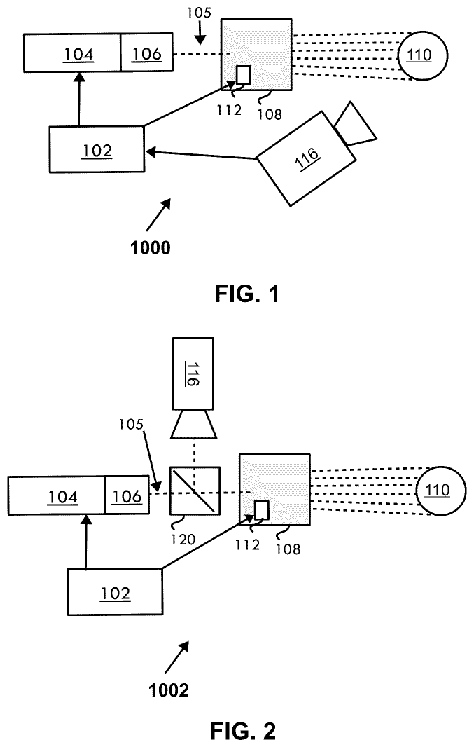

Referring to FIG. 1, shown is a light steering system 1000 according to non-limiting embodiments. A light source 104, such as a laser, is arranged to emit at least one light beam 105 toward a target (e.g., such as an object 110 or scene). A lens 106 may be arranged in a path of the light source to focus the light beam 105. It will be appreciated that various types of light sources, including different types of lasers and/or other optical devices (such as but not limited to lenses, mirrors, and/or the like) may be used to emit and/or manipulate a light beam 105. In non-limiting embodiments, the light beam 105 may be generated without the use of moving parts (e.g., such as motors).

With continued reference to FIG. 1, a controller 102 (e.g., such as a computing device) may be in communication with the light source 104 to control the light source 104 (e.g., to pulse and/or otherwise affect the output of the light source 104). As discussed further herein, the controller 102 may use a signal generator to drive the light source. Although FIG. 1 shows a single controller 102, it will be appreciated that one or more controllers may be used in the light steering system 1000, such as but not limited to one or more controllers integrated with or local to the light source 104, one or more external controllers, one or more network controllers, and/or the like.

Still referring to FIG. 1, a medium 108 is arranged in a path of the light beam 105 between the light source 104 and the object 110 or scene. The medium 108 may include a substance arranged in a container. For example, the medium 108 may include water, polymers, and/or any other substances that are at least partially transparent to allow the light beam 105 to pass through. The medium 108 may be any liquid, gas, and/or solid substance through which light can travel and that can be sculpted by the pressure of sound waves. In some non-limiting embodiments, the medium 108 may include one or more polymers, such as but not limited to epoxy, through which a sonic waveform can move faster as compared to water. In non-limiting embodiments, polymers that can withstand a relatively higher amount of pressure may be used to maintain the structure of the medium during use. In some non-limiting embodiments, a solid medium, such as tellurium dioxide glass, may be used to increase the speed that a sonic waveform travels.

As shown in FIG. 1, in non-limiting embodiments, a device 112 is arranged in or near the medium 108 to produce sonic waveform(s) within the medium 108. For example, the device 112 may include one or more transducers at least partially submerged in the medium 108 that, when supplied with energy, produce one or more ultrasonic waves that convey through the medium 108. Additionally or alternatively, the device 112 may be arranged outside the medium 108 such that a sonic waveform is conveyed into and/or through the medium 108. In some non-limiting embodiments, the device 112 may include two transducers arranged at an angle relative to each other (e.g., arranged orthogonally or at any other angle). It will be appreciated that various numbers and arrangements of transducers may be used in non-limiting embodiments.

In non-limiting embodiments, the light source 104, lens 106, medium 108, and/or controller 102 may be arranged in a housing as a device. In other non-limiting embodiments, the light source 104, lens 106, medium 108, and/or controller 102 may be separate devices.

In non-limiting embodiments, the medium 108 may be arranged in a container. The container and/or medium 108 may be cubic, rectangular, cylindrical, or any other shape that allows for light beams and sonic waveforms to pass through it. The medium 108 may be any size, and may be implemented in non-limiting embodiments at a millimeter scale (e.g., each dimension being 1-50 mm or the like). It will be appreciated that larger sizes may also be used. The container may include, for example, a glass or acrylic tank. In non-limiting embodiments in which the medium 108 is a solid, there may be no container used.

With continued reference to FIG. 1, the controller 102 may be in communication with the device 112 to generate the sonic waveform. Although FIG. 1 shows a single controller 102, it will be appreciated that one or more controllers may be used in the light steering system 1000, such as but not limited to one or more controllers integrated with or local to the device 112, one or more external controllers, one or more network controllers, and/or the like. In non-limiting embodiments, the controller 102 may be configured to modulate (e.g., alter the amplitude and/or frequency of) the sonic waveform being produced by the device 112 by modulating the voltage being supplied to the device 112. For example, the controller 102 may cause the phase of the sonic waveform to be modulated. The controller 102 in non-limiting embodiments may include and/or be in communication with one or more signal generators for generating the modulated voltage. One or more power amplifiers may be used in connection with the one or more signal generators.

Still referring to FIG. 1, in non-limiting embodiments the light source 104 may be synchronized with the sonic waveform produced by the device 112. For example, in non-limiting embodiments in which the light source 104 is a laser, the laser may have a configurable pulse pattern (e.g., such as a pulse repetition frequency). The controller 102 may set the pulse pattern based on (e.g., to substantially match) the frequency of the sonic waveform.

The light steering system 1000 shown in FIG. 1 also includes a sensor 116, such as a camera, with a field of view that includes the object 110 or scene. The sensor 116 may be any type of optical sensor (e.g., optical detector), including but not limited to one or more cameras, photodiodes, detector arrays, gated single-photon avalanche diodes (SPADs), and/or the like. The sensor 116 may be in communication with the controller 102 and/or a different controller, such as but not limited to one or more controllers integrated with or local to the sensor 116, one or more external controllers, one or more network controllers (e.g., such as server computers), and/or the like. The sensor 116 may be in communication with one or more signal generators for controlling an exposure rate of the sensor 116. The sensor 116 may detect and/or capture reflections of the light beam 105 off the object 110 or scene (e.g., illumination reflected by the object 110 or scene) as the light beam 105 scans the object 110 or scene.

Non-limiting embodiments of the light steering system 1000 shown in FIG. 1 allows for both the focal length and the partial location to be changed at high speeds. This allows for the medium 108 to act as an ultrasonically-sculpted lens that steers light beams in both axial and transverse directions. In non-limiting embodiments, the polarization of one or more light beams may be changed by passing through the medium 108 as it is sculpted into a lens with an ultrasonic waveform.

Non-limiting embodiments of the light steering system 1000 shown in FIG. 1 may be used to scan one or more surfaces of an object 110 or scene to obtain 3D point cloud data. Additionally or alternatively, the light steering system 1000 may be used to project one or more images on one or more surfaces of an object 110 or scene. Although several embodiments described herein relate to scanning a 3D surface from a single perspective to obtain depth measurements for each point, it will be appreciated that a wider degree of scanning may be obtained (e.g., such as a 360 degree scan) through the use of one or more conical mirrors and/or the like.

In non-limiting embodiments, the device 112 may include one or more planar transducers driven with a voltage (e.g., such as a sinusoidal voltage). It will be appreciated that any shape of transducer may be used in non-limiting embodiments and any waveform could also be used. As an example, in non-limiting embodiments two planar piezo transducers (e.g., such as P-25.40 mm-25.40 mm-2.10 mm-880-WFB, from APC International, Ltd) may be arranged at an angle (e.g., orthogonal or any other angle) relative to each other and at an inclination (e.g., 45° or the like) relative to the sides of the container containing the medium 108 to minimize interference from inter-reflections. It will be appreciated that various types and arrangements of transducers may be used. In non-limiting embodiments, the device 112 may be driven with a signal generator (e.g., separate or integrated with controller 102) via a power amplifier.

The resulting pressure P (x, t) inside the medium equals:

$$P ( x , t ) = {P}_{o} + {P}_{s} cos ( {k}_{us} x - {ω}_{us} t ) , \qquad ( 1 )$$

where: t is time, x is distance normal to the transducer plane (the pressure is independent of y and z coordinates), Pₒ is the medium pressure without ultrasound, Pₛ is proportional to the transducer voltage amplitude, and the remaining parameters are as follows:

| quantity | symbol |
|---|---|
| speed | cᵤₛ |
| wavelength | λᵤₛ |
| frequency | fᵤₛ |
| angular frequency | ωᵤₛ = 2πfᵤₛ |
| wavenumber | kᵤₛ = 2πλᵤₛ⁻¹ |
| timeperiod | Tᵤₛ = fᵤₛ⁻¹ |

The refractive index n(x, t) of the medium changes proportionally to the pressure as follows:

$$n ( x , t ) = {n}_{o} + {n}_{s} cos ( {k}_{us} x - {ω}_{us} t ) , \qquad ( 2 )$$

where: nₒ is the refractive index of the medium without the transducer, nₛ=kPₛ, and k is an empirical coefficient (k=1.402×10⁻⁵ bar⁻¹ for water).

At time t=0, the convex lobes of this refractive index profile (regions x=[Iλᵤₛ−λᵤₛ/2, Iλᵤₛ+λᵤₛ/2]; IϵZ) act as GRIN lenses. Each of these lenses focus light rays traveling parallel to the transducer onto a line. The lens focal length and aperture can be changed by varying the amplitude and frequency of the transducer voltage.

The pressure wave and refractive index profile propagate along the x-direction. Thus, the convex lobes vary as: x(t)=[cust+1λᵤₛ−λᵤₛ/2, cust+Iλᵤₛ+λᵤₛ/2]; IϵZ. As a result, ultrasonically-sculpted cylindrical GRIN lenses are dynamic and focused lines travel normal to the transducer at the speed of ultrasound.

The speed and/or location of the lens focus can be achieved in non-limiting embodiments by using a pulsed laser with the same pulse pattern (e.g., repetition frequency) as the ultrasound frequency and programmable phase modulation for the transducer voltage.

With the use of a single transducer, due to phase modulation, the pressure pattern from Equation (1) becomes P (x, t)=Pₒ+Pₛ cos(kᵤₛx−wᵤₛt−φ(t)). If the illumination is continuous, the position of the focused light is xₙ(t)=cᵤₛt−nλᵤₛ,+(φ(t)/2π)λ; nϵZ, which is a set of lines moving continuously at the speed of sound. By pulsing the illumination at an ultrasound frequency, a set of lines may be produced that flicker at the ultrasound frequency: xₙ(mTᵤₛ)=(m−n)λᵤₛ+(φ(mTᵤₛ))/2π) λᵤₛ. If the phase is modulated linearly (φ(t)=kωᵤₛt; k<1), it results in x(mTᵤₛ)=mkcᵤₛTᵤₛ for m=n (e.g., the line due to the same laser and ultrasound pulse). Therefore, the lines travel at reduced speed kcᵤₛ.

In non-limiting embodiments, two transducers arranged at an angle (e.g., orthogonal or any angle) may be used to focus light to a point. Such an arrangement may be used to control a focus point to a raster scan at the laser repetition frequency, which is higher than an ultrasound frequency (e.g., 1 MHz), and/or to scan arbitrary point locations at the ultrasound frequency.

Non-limiting embodiments may implement arbitrary point scanning to rescan one or more portions of an object and/or scene to obtain more accurate data. To scan arbitrary points (x(mTᵤₛ), y(mTᵤₛ)) for each laser pulse m, the phases φₓ(t) and φ_{y}(t) of both transducers may be modulated. The focus point location within the region [0, λᵤₛ]×[0, λᵤₛ] is shown as:

$$x ( t ) = ( {ϕ}_{x} ( t ) / {k}_{us} + {c}_{us} t ) mod {λ}_{us} , \qquad ( 3 )$$

$$y ( t ) = ( {ϕ}_{y} ( t ) / {k}_{us} + {c}_{us} t ) mod {λ}_{us} , \qquad ( 4 )$$

To scan a set of points (x(mTᵤₛ), y(mTᵤₛ)), the phases (φₓ(mTᵤₛ), φ_{y}(mTᵤₛ)) are computed using Equations (3)-(4) and interpolated to compute (φₓ(t), φ_{y}(t)).

Arbitrary point scanning may be used to raster scan a 2D grid of points. In such a case, the phase modulation for raster scanning would be linear, (φₓ(t), φ_{y}(t))=(kₓωᵤₛt, k_{y}ωᵤₛt), where kₓ and k_{y} are phase modulation rates. The phase modulation rate for the faster axis would be equal to the product of the number of scan points and the modulation rate of the slower axis. The raster scanning frequency of this approach would be based on the ultrasound frequency. If the laser repetition frequency is higher, more points can be scanned in a time period by running the laser at its highest frequency. Their locations can be shown as:

$$x ( {mT}_{L} ) = ( {mk}_{x} ) \frac{{λ}_{us}}{s} mod {λ}_{us} , \qquad ( 5 )$$

$$y ( {mT}_{L} ) = ( {mk}_{y} ) \frac{{λ}_{us}}{s} mod {λ}_{us} , \qquad ( 6 )$$

where s=f_{L}/fᵤₛ is the ratio of laser (f_{L}) and ultrasound (fᵤₛ) frequencies, and T_{L}=1/f_{L} is the inter-pulse time.

Referring now to FIG. 2, shown is a light steering system 1002 according to non-limiting embodiments. The components shown in light steering system 1002 may be the same as the components with like numbers described herein in relation to the light steering system 1000 shown in FIG. 1. In non-limiting embodiments, the sensor 116 may be arranged to receive the reflected light beams directly, without passing through the medium 108. In other non-limiting embodiments, and as shown in FIG. 2, the sensor 116 may be arranged to receive the reflected light beams through the medium 108. In FIG. 2, a beam splitter 120 is used to reflect the light reflected from the object 110 or scene and received through the medium 108. In other non-limiting embodiments, the sensor 116 may be arranged substantially aligned with the light source 104.

With reference to FIGS. 1 and 2, in non-limiting embodiments the sensor 116 may be a gated single-photon avalanche diode (SPAD). The sensor 116 may be synchronized to the light source 104 and device 112. In a non-limiting implementation, a first signal generator and a second signal generator may be synchronized with respect to clock and trigger signals. The first signal generator may drive the device 112 to produce the sonic waveform and the second signal generator may drive the light source 104 and the sensor 116 (e.g., through two respective channels of the second signal generator). It will be appreciated that various other arrangements may be used to synchronize the light source 104, device 112, and/or sensor 116.

With continued reference to FIGS. 1 and 2, in non-limiting embodiments the lens 106 arranged in an optical path of the light source 104 may create a diverging ray that is focused through the medium 108 acting as an ultrasonically-sculpted lens. In some non-limiting embodiments, an aperture device (not shown) may be arranged in an optical path between the medium 108 and the object 110 or scene to limit the scanning area to only one ultrasonic period. In some non-limiting embodiments, there may not be a lens arranged in front of the sensor 116 since the medium 108, via the ultrasonically sculpted lens, focuses light reflected from the object onto the sensor 106.

Non-limiting embodiments described herein may be adapted for use as a LiDAR scanning system. In such an arrangement a gated SPAD may be used as the sensor 116 for obtaining depth and transient measurements. The gate of the sensor 116 helps reject backscattered photons from various optics. A signal generator may be used to drive the SPAD gate instead of a picosecond delayer (PSD), which is used in SPAD-based LiDAR systems. Such a LiDAR arrangement generates programmable delays at a higher resolution (e.g., 1 μs) than a PSD-based arrangement (e.g., 50 ns).

In non-limiting embodiments, both the transducer and SPAD signal generators may be operated in burst mode with the trigger running at 100 Hz, as an example, for synchronization. A picoharp or other like device may be used to measure the time-of-flight of the photons and to synchronize the scanning position. Since the scanning of a LiDAR arrangement according to non-limiting embodiments runs at a higher speed than a galvo-mirror-based scanning system, an external synchronization signal would produce a large number of marker events. Instead, in non-limiting embodiments, the pulse index of the picoharp (output for each laser pulse detected) may be used to compute when the photon and Equations 5-6 can be used to compute the scan position.

In non-limiting embodiments, the pulsed raster scanning technique described herein may be used to raster scan the object 110 or scene. Control parameters may be set as follows in non-limiting embodiments: f_{L}=50 MHz, fᵤₛ=1 MHz, kₓ=1.0001, and k_{y}=1.01. These settings may result in a 100×100 spatial resolution and scan rate of 5000 frames per second. With just a single sensor/laser (single channel), 50 million points per second may be scanned. This is a material improvement over existing high-end LiDAR systems that use 128 channels and scans 5 million points per second.

In non-limiting embodiments of a LiDAR arrangement using the light steering systems and methods described herein, an arbitrary point scanning technique as described herein may be used to selectively scan the depths of a few points in the field of view. An advantage of such an approach is the potential for adaptive scanning. Ultrasonic beam steering shifts the focus within the time period of the two laser photons (e.g., 1 μs) and does not waste any pulses that would be otherwise wasted during the travel time using galvo mirrors. As a result, non-limiting embodiments may provide a depth estimation accuracy of 250 times higher than that of arrangements utilizing galvo mirrors.

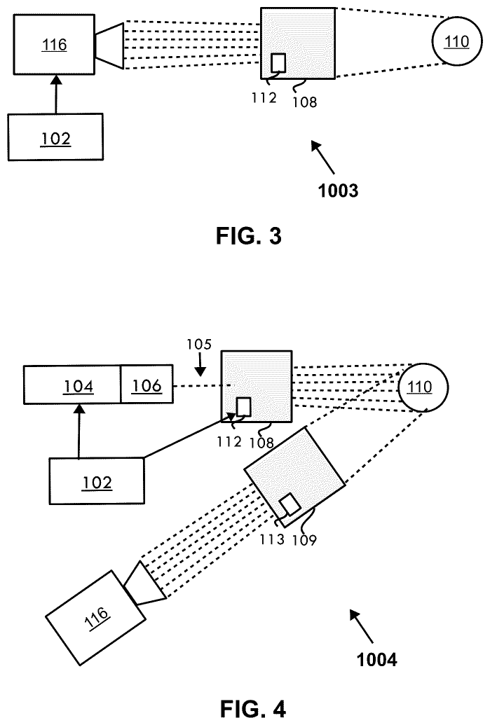

Referring now to FIG. 3, shown is a light steering system 1003 according to non-limiting embodiments. The example arrangement shown in FIG. 3 does not include a light source. Instead, light beams reflected by the object 110 or scene are received in the medium 108 and steered into a field of view of a sensor. The reflected light may include ambient light and/or one or more light sources. The medium 108 may be as described in connection with FIG. 1. A device 112, also as described in connection with FIG. 1, produces a sonic waveform in the medium 108 that steers the reflected light to a field of view of the sensor 116. In non-limiting embodiments, the sensor 116 may have an exposure rate that is synchronized with the sonic waveform produced in the medium 108 such that only a subset of light is received by the sensor 116.

Referring now to FIG. 4, shown is a light steering system 1004 according to non-limiting embodiments. The components shown in light steering system 1004 may be substantially the same as the like-numbered components described herein in relation to the light steering system 1000 shown in FIG. 1 and the light steering system shown in FIG. 2. In this example, two mediums 108, 109 are used, such that a first medium 108 steers light beams emitted from the light source 104 onto an object 110 or scene, and a second medium 109 steers light beams reflected from the object 110 or scene into a field of view of the sensor 116. The device 109 may substantially the same as the device 112 described in connection with FIG. 1. The sensor 116 in this arrangement may be arranged outside the optical path of the medium 108 and light source 104, and the reflected illumination may be steered to a focal point and/or field of view of the sensor 116 in a separate optical path as shown.

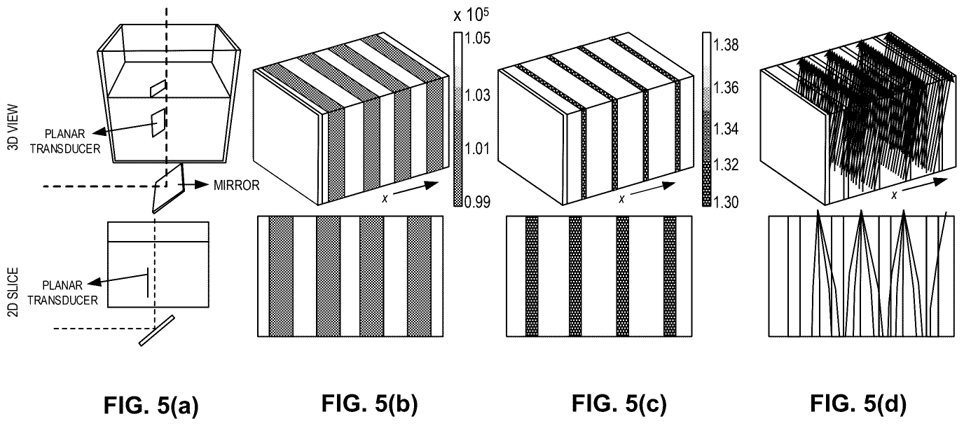

Referring to FIGS. 5(a)-(d), 2D and 3D views of the medium are shown. FIG. 5(b) shows a representation of a pressure wave aspect of the sonic waveform. Since sound is a pressure wave, the pressure inside the medium varies spatially based on the voltage waveform applied with the transducer(s). FIG. 5(c) shows the change in refractive index of the medium, which is proportional to the pressure wave shown in FIG. 5(b). Therefore, the refractive index of the medium also varies spatially, turning the medium into a GRIN lens. FIG. 5(d) shows a ray diagram of light beams passing through the GRIN lens that curve continuously and focus on a set of lines. The focal length of the lens created in the medium may be a function of the voltage and frequency applied to the transducer.

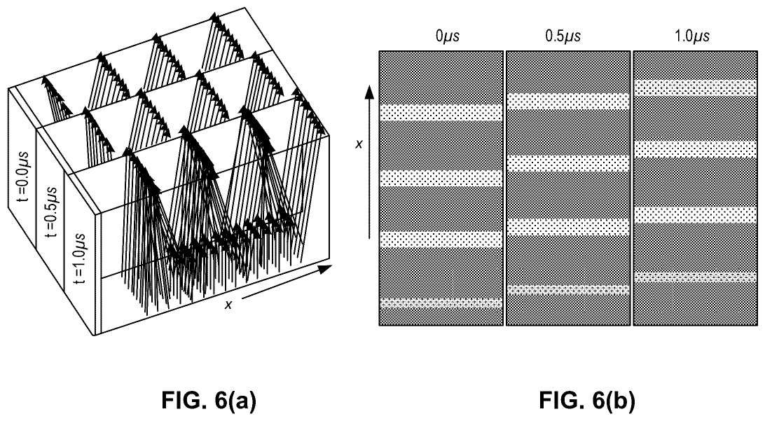

Referring to FIGS. 6(a)-(b), 2D and 3D views of the medium are shown while a planar transducer steers a light beam. As sound propagates, the spatial refractive index pattern also propagates at the speed of sound. The focused light, which is a set of lines, also travels normal to the transducer plane at the speed of sound. The images shown in FIG. 6(b) show that the planar transducer moves the focus region (e.g., a line in this example) at the speed of sound.

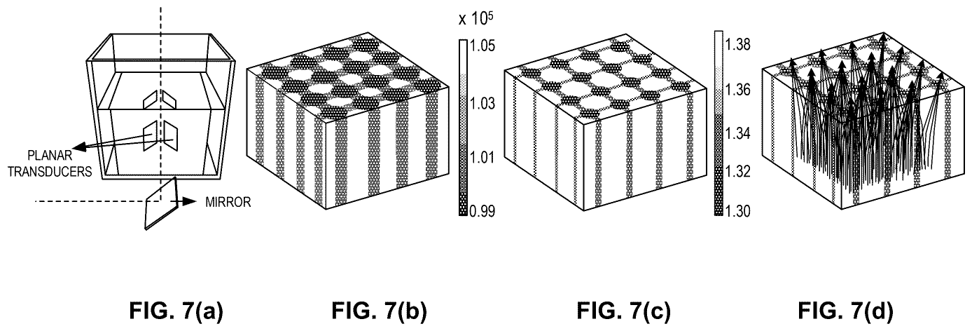

Referring to FIGS. 7(a)-(d), 3D views of the medium are shown while light beams are focused to a point. FIG. 7(b) shows the pressure wave inside the medium as a superposition of the pressure waves generated by the transducer(s). FIG. 7(c) shows the change in refractive index as proportional to the net pressure shown in FIG. 7(b). FIG. 7(d) shows light beams from a wide beam focused on a set of points (e.g., restricting reflected illumination beam size) to focus light on a single point for purposes of capturing it with the sensor.

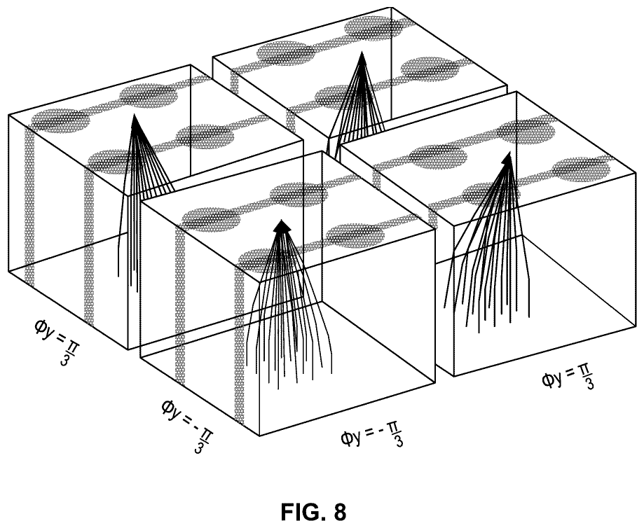

Referring to FIG. 8, mediums in different stages of light steering are shown. By controlling the phases of the voltage (e.g., sinusoidal voltage) applied to the transducer(s), the location of the focus position can be controlled. To continually steer the focus location (e.g., to different portions of a sensor), the phase of the voltage applied to both transducers is modulated.

In non-limiting embodiments of the light steering system described herein, spatiotemporal resolution may be improved, and uncertainty lessened, by decreasing the focal length of the waveguide produced in the medium with the sonic waveform by increasing the voltage applied to the transducer(s).

In non-limiting embodiments of the light steering system described herein, resolutions may be improved (e.g., including aperture, spatial, and temporal resolutions) by using a medium having a higher speed of sound. As an example, tellurium dioxide (TeO₂) glass has a speed of sound three times higher than water and a 50% higher refractive index. Using tellurium dioxide glass or another material with a higher speed of sound may improve the light efficiency of the system by at least an order of magnitude over using water, while simultaneously improving the spatial resolution by five times. Tellurium dioxide is a solid and is therefore more stable compared to liquid. It will be appreciated that various other materials and substances may be used as the medium based on how the medium conveys sound waves.

Each transducer may create a cylindrical lens with the medium. In non-limiting embodiments using two transducers arranged at an angle relative to one another, the net effect of these two cylindrical lenses is a square aperture associated with a Fourier transform that is the product of two one-dimensional slices. Therefore, the blur kernel of the light beam that is output by the medium has a cross shape. In non-limiting embodiments, the blur kernel may be modified to be closer to a Gaussian-like blur kernel by using multiple transducers arranged around a circular path and synchronized. Based on the application, deconvolution techniques may be used in some non-limiting embodiments to improve the results in post-processing.

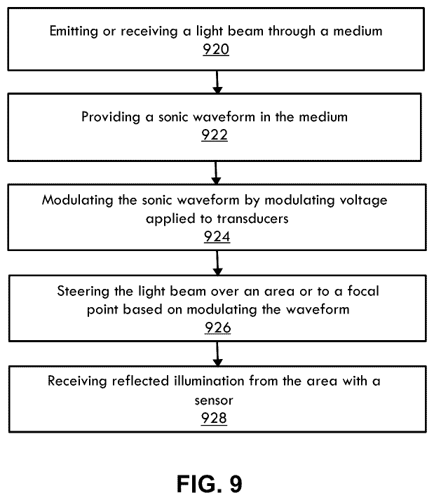

Referring now to FIG. 9, a method for light steering is shown according to non-limiting embodiments or aspects. It will be appreciated that the order of the steps shown in FIG. 9 is for illustrative purposes only and that non-limiting embodiments may involve more steps, fewer steps, different steps, and/or a different order of steps. In non-limiting embodiments or aspects, each step and/or one or more steps in FIG. 9 may be performed automatically in response to the completion of a previous step. At step 920, a light beam is emitted and/or received through a medium. As described herein, the arrangement of a medium with respect to a target (e.g., an object and/or scene) may be used to steer a light beam over the target and/or to focus light reflected from the target to a sensor.

At step 922 of FIG. 9, a sonic waveform is produced in the medium. As described herein, the sonic waveform may be produced using one or more transducers arranged in and/or on the medium or outside the medium. At step 924, the sonic waveform may be modulated by modulating the voltage applied to the transducers. The modulated waveform may be synchronized with the light source, such as the pulse pattern of a laser, so that each pulsed light beam is steered based on the waveform produced in the medium at the time it passes through. At step 926, the light beam is steered over an area including a target in arrangements in which light is emitted at step 920. In such arrangements, the method may continue to step 928 in which a sensor receives illumination reflected from the target (e.g., directly, through the medium, or through a second medium). At step 926, in arrangements in which light is received at step 920, the light beams received in the medium may be steered to a field of view of a sensor and step 928 may not be performed.

In non-limiting embodiments, a light steering system as described herein may be simulated with a physics-based rendering engine. The rendering engine, which may be software and/or hardware (e.g., such as a software application executed by at least one computing device), may be implemented in non-limiting embodiments without having knowledge of the refractive index field associated with the material, as the refractive index is determined through simulation of a sonic waveform. In some non-limiting embodiments, the rendering engine may be executed by one or more Graphical Processing Units (GPUs) for faster processing by at least an order of magnitude from a CPU.

The rendering engine may be used to simulate the effects of different input voltages, different input frequencies, different transducer arrangements, different transducer shapes, different materials, and/or the like.

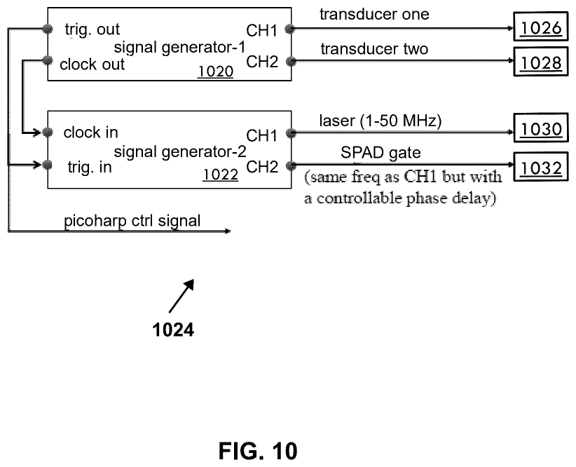

FIG. 10 shows a signal generator arrangement 1024 for controlling a light source 1030, transducer(s) 1026, 1028, and a sensor 1032 according to non-limiting embodiments. The arrangement shown includes a first signal generator 1020 with two output channels connected to two transducers 1026, 1028. The arrangement also includes a second signal generator 1022 with two output channels connected to a light source 1030 (laser in FIG. 10) and a sensor 1032 (SPAD gate in FIG. 10). The output channel (CH2) connected to the SPAD gate 1032 may be set to the same frequency as the output channel (CH1) connected to the laser 1030 with a controllable phase delay since the SPAD gate 1032 will receive the reflected illumination from the target at a delay from the laser pulse and use the phase-delayed version of the laser signal to capture the light beams. It will be appreciated that any number of signal generators, output channels, and/or transducers may be used in non-limiting embodiments.

With continued reference to FIG. 10, to synchronize the transducers with the laser and SPAD gate, a clock signal and trigger signal may be output from the first signal generator 1020 and input to the second signal generator 1022. In non-limiting embodiments in which the system is configured as a projector, the transducers may receive phase-modulated sinusoidal input signals corresponding to the projected dot pattern from the signal generator 1020, the laser may receive a Transistor-Transistor Logic (TTL) signal with the same frequency as the transducers from the second signal generator 1022, and the SPAD gate may receive the phase-delayed version of the signal output to the laser. In a raster scanning configuration, the laser may receive the highest frequency signal that the laser can operate on with the second signal generator 1022 and the other output signals may be as described with respect to the dot projection configuration. As described herein, the signal generators 1020, 1022 may be controlled by and/or integrated with a controller.

To optically align non-limiting implementations of the light steering system described herein, the following steps may be performed. It will be appreciated that the steps are shown as an example and that one or more steps listed below may be omitted, changed, and/or additional steps added in accordance with different non-limiting embodiments. (1) Arrange the light source (e.g., laser), sensor (e.g., SPAD), and transducers on a 3D stage. (2) Collocate the light source and sensor using a beam splitter arranged in an optical path of the light source and an optical path of the sensor. (3) Place a zoom lens between the laser and the beam splitter, keeping the zoom lens at the lowest focal length to diverge the beam to a large area. (4) Arrange the medium in an optical path of the light source and after the beam splitter. (5) Arrange a first transducer in the medium. The first transducer may be arranged parallel to the beam and at a 45 degree tilt to the bottom of the medium (e.g., the container holding the medium or the medium itself), as an example. (6) Connect the first transducer to the output of an amplifier and drive the amplifier with a first signal generator. (7) Drive the transducer and the light source (e.g., laser) at the same frequency (e.g., 1 MHz), such that the light beam focuses on a few lines. If the frequency of the transducer is changed slightly, the lines will travel at the beat frequency (e.g., the rate at which the soundwave oscillated from high to low). The reflections of ultrasound can be visualized at this stage. (8) Align the first transducer so the reflections do not overlap with the traveling sound wave. (9) Arrange a second transducer in the medium and repeat the above steps (6)-(7) with the same or a second signal generator. (10) Confirm that the lines generated by both transducers are orthogonal. When both the transducers are turned on, they will form a grid of lines that intersect at dots. If the transducers are at a different distance from the zoom lens, the result will be a rectangular display. Interreflections may decrease the quality of the projection. (11) Increase the focal length of the zoom lens until only one focal region is illuminated. If the illumination still produces multiple focal regions, place an aperture after the medium to crop and illuminate only one focal region. (12) Place a retroreflective dot at the focal point. (13) Run the sensor (e.g., SPAD) in free running mode and spatially translate the sensor until its photon count is highest. This ensures that the sensor and light source are aligned. (14) Change the sensor (e.g., SPAD) to run in gated mode. (15) Delay the gate signal to reject light backscattered by optics by changing the phase of the input waveform to the sensor gate.

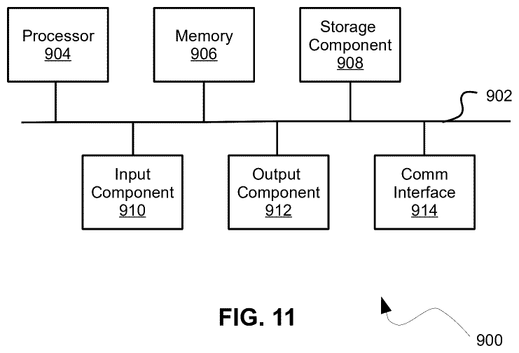

Referring now to FIG. 11, shown is a diagram of example components of a computing device 900 for implementing and performing the systems and methods described herein according to non-limiting embodiments. In some non-limiting embodiments, device 900 may include additional components, fewer components, different components, or differently arranged components than those shown in FIG. 11. Device 900 may include a bus 902, a processor 904, memory 906, a storage component 908, an input component 910, an output component 912, and a communication interface 914. Bus 902 may include a component that permits communication among the components of device 900. In some non-limiting embodiments, processor 904 may be implemented in hardware, firmware, or a combination of hardware and software. For example, processor 904 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 906 may include random access memory (RAM), read only memory (ROM), and/or another type of dynamic or static storage device (e.g., flash memory, magnetic memory, optical memory, etc.) that stores information and/or instructions for use by processor 904.

With continued reference to FIG. 11, storage component 908 may store information and/or software related to the operation and use of device 900. For example, storage component 908 may include a hard disk (e.g., a magnetic disk, an optical disk, a magneto-optic disk, a solid state disk, etc.) and/or another type of computer-readable medium. Input component 910 may include a component that permits device 900 to receive information, such as via user input (e.g., a touch screen display, a keyboard, a keypad, a mouse, a button, a switch, a microphone, etc.). Additionally, or alternatively, input component 910 may include a sensor for sensing information (e.g., a photo-sensor, a thermal sensor, an electromagnetic field sensor, a global positioning system (GPS) component, an accelerometer, a gyroscope, an actuator, etc.). Output component 912 may include a component that provides output information from device 900 (e.g., a display, a speaker, one or more light-emitting diodes (LEDs), etc.). Communication interface 914 may include a transceiver-like component (e.g., a transceiver, a separate receiver and transmitter, etc.) that enables device 900 to communicate with other devices, such as via a wired connection, a wireless connection, or a combination of wired and wireless connections. Communication interface 914 may permit device 900 to receive information from another device and/or provide information to another device. For example, communication interface 914 may include an Ethernet interface, an optical interface, a coaxial interface, an infrared interface, a radio frequency (RF) interface, a universal serial bus (USB) interface, a Wi-Fi®interface, a cellular network interface, and/or the like.

Device 900 may perform one or more processes described herein. Device 900 may perform these processes based on processor 904 executing software instructions stored by a computer-readable medium, such as memory 906 and/or storage component 908. A computer-readable medium may include any non-transitory memory device. A memory device includes memory space located inside of a single physical storage device or memory space spread across multiple physical storage devices. Software instructions may be read into memory 906 and/or storage component 908 from another computer-readable medium or from another device via communication interface 914. When executed, software instructions stored in memory 906 and/or storage component 908 may cause processor 904 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “programmed or configured,” as used herein, refers to an arrangement of software, hardware circuitry, or any combination thereof on one or more devices.

Although embodiments have been described in detail for the purpose of illustration, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

1. A method comprising:
emitting or receiving at least one light beam through a medium;
providing a sonic waveform in the medium while the at least one light beam is emitted through the medium; and
steering the at least one light beam by modulating the sonic waveform.

2. The method of claim 1, further comprising:
synchronizing at least one of the following: a light source of the at least one light beam with the sonic waveform, a sensor arranged to receive reflected illumination from the at least one light beam with the sonic waveform, or any combination thereof, wherein the light source comprises a laser, wherein synchronizing the light source comprises setting a pulse pattern of the laser to a frequency of the sonic waveform, and wherein emitting the at least one light beam through the medium comprises pulsing the at least one light beam based on the pulse pattern.

3. (canceled)

4. The method claim 1, further comprising:
scanning a three-dimensional target based on steering the at least one light beam over an area including the target, the target comprising at least one of an object or scene; and
projecting at least one image on a target based on steering the at least one light beam over an area of the target.

5. (canceled)

6. The method of claim 1, wherein providing the sonic waveform in the medium comprises:
arranging at least one transducer in the medium; and
generating an ultrasonic wave with the at least one transducer, the sonic waveform comprising the ultrasonic wave.

7. The method of claim 6, wherein the at least one transducer comprises a first transducer and a second transducer, the second transducer arranged at an angle relative to the first transducer.

8. The method of claim 1, further comprising:
scanning a target comprising at least one of a scene or object by steering the at least one light beam based on a ratio of frequencies from the light source and the sonic waveform, and an inter-pulse time of the light source.

9. The method of claim 4, further comprising:
identifying at least a portion of the target to be rescanned based on measured data associated with a plurality of points in the at least a portion; and
rescanning the at least a portion of the target based on steering the at least one light beam.

10-11. (canceled)

12. The method of claim 1, wherein the at least one light beam is emitted through the medium from a light source to a target, further comprising:
receiving, by a sensor, at least one second light beam through the medium or a second medium from illumination reflected by the target.

13. A system comprising:
a medium arranged in a path of at least one light beam; and
at least one controller configured to steer the at least one light beam by modulating a sonic waveform in the medium.

14. (canceled)

15. The system of claim 13, further comprising at least one transducer arranged in or near the medium and configured to generate the sonic waveform in the medium.

16. The system of claim 15, wherein the at least one transducer comprises a first transducer and a second transducer, the second transducer arranged at an angle relative to the first transducer

17. The system of claim 13, wherein the controller is further configured to synchronize the light source with the sonic waveform, wherein the light source comprises a laser, wherein synchronizing the light source comprises setting a pulse pattern of the laser to a frequency of the sonic waveform, and wherein the at least one controller is configured to pulse the at least one light beam at the pulse pattern.

18. (canceled)

19. The system of claim 13, wherein the controller is further configured to:
scan a target comprising at least one of a scene or object based on steering the at least one light beam over an area including the target; and
project at least one image on a target comprising at least one of the scene or object based on steering the at least one light beam over the target.

20. (canceled)

21. The system of claim 19, wherein the controller is further configured to:
identify at least a portion of the target to be rescanned based on measured data associated with a plurality of points in the at least a portion of the target; and
rescan the at least a portion of the target based on steering the at least one light beam

22. (canceled)

23. The system of claim 13, further comprising:
a second medium, wherein at least one second light beam is received by the sensor through the second medium from illumination reflected by a target.

24. The system of claim 13, wherein the controller is further configured to:
scan a target comprising at least one of a scene or object by steering the at least one light beam based on a ratio of frequencies from the light source and the sonic waveform and an inter-pulse time of the at least one light source.

25. The system of claim 13, further comprising:
at least one signal generator in communication with the controller, the controller configured to modulate the sonic waveform by generating a modulated voltage signal with the at least one signal generator.

26. The system of claim 25, wherein the at least one signal generator comprises a first signal generator and a second signal generator, the first signal generator configured to provide a signal to at least one transducer for providing the sonic waveform, the second signal generator configured to provide signals to a light source of the at least one light beam and a sensor arranged to receive illuminated reflection from the at least one light beam.

27. (canceled)

28. An apparatus comprising a non-transitory computer-readable medium including program instructions that, when executed by at least one controller, causes the at least one controller to:
generate a sonic waveform in a medium; and
steer at least one light beam passing through the medium by modulating the sonic waveform.

29-46. (canceled)

47. The method of claim 1, wherein the medium comprises at least one of the following: a polymer, water, tellurium dioxide glass, or any combination thereof.
